(19) United States
(12) Patent Application Publication
(10) Pub. No.: US 2009/0250937 A1
(43) Pub. Date: Oct. 8, 2009

(54) Relative wind vortex rotary turbine alternating current device (RWVT)

(76) Inventor: Manuel I. Stuart, Santa Cruz, CA (US)

Correspondence Address: RONALD J. MEETIN, ATTORNEY AT LAW, 210 CENTRAL AVENUE, MOUNTAIN VIEW, CA, 94043-4869, US

(21) Appl. No.: 12/082,047

(22) Filed: Apr. 7, 2008

(51) Int. Cl. F03D 9/00

(52) U.S. Cl. 290/55

(57) ABSTRACT

The present invention is an RWVT for converting relative wind energy into electrical energy using a vortex that leads into an axial flow rotary turbine alternator which provides energy for operating a generator. The result is renewable energy that can be scaled for all energy requirements. Said axial flow rotary turbine is cylindrical in shape and mounted in a forward to aft position to capture relative wind most effectively in the vortex. The RWVT may be used in many diverse applications with minimal modifications. The applications include, but are not limited to, land, water and air vehicles, as well as, structures and objects—anywhere relative wind may be captured.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

The field of endeavor to which this invention pertains, focuses on converting renewable wind energy to mechanical energy, creating electrical energy through a relative wind vortex alternating current device.

### BRIEF SUMMARY OF THE INVENTION

The present invention is generally designed to a produce a RWVT which is efficient and emits zero pollutants. The rotating turbine airfoil is comprised of the advanced material, Karvlar™, giving it unparalleled strength and weight with minimal maintenance. Applications can be utilized on many types of vehicles and structures using relative wind energy from a variety of sources. For example, relative wind energy can be captured in cities with tall buildings by utilizing the natural wind currents occurring between the buildings due to the deferring temperature and pressure variations. In addition to use on vehicles and buildings, this RWVT can be used anywhere relative wind is created due to pressure changes from temperature and/or mass. For example, the RWVT can be set up near black rubber, painted concrete or asphalt surfaces, the underpass of a bridge, tunnels and along the sides of highways for purpose of generating power for a public grid.

### BRIEF DESCRIPTION OF THE SEVERAL VIEWS OF THE DRAWING

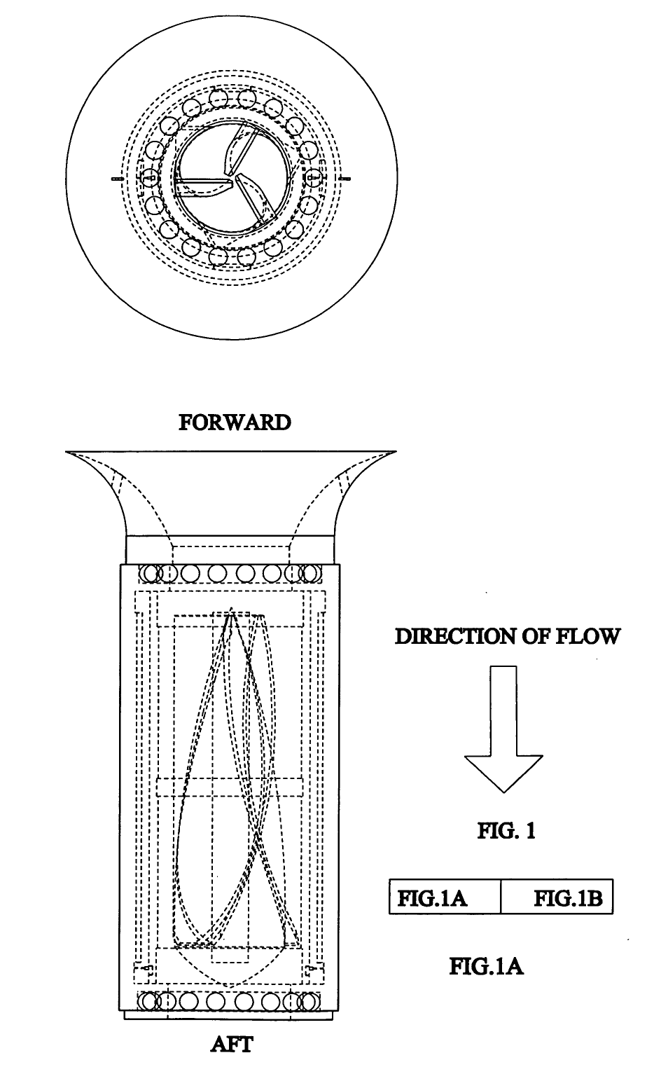

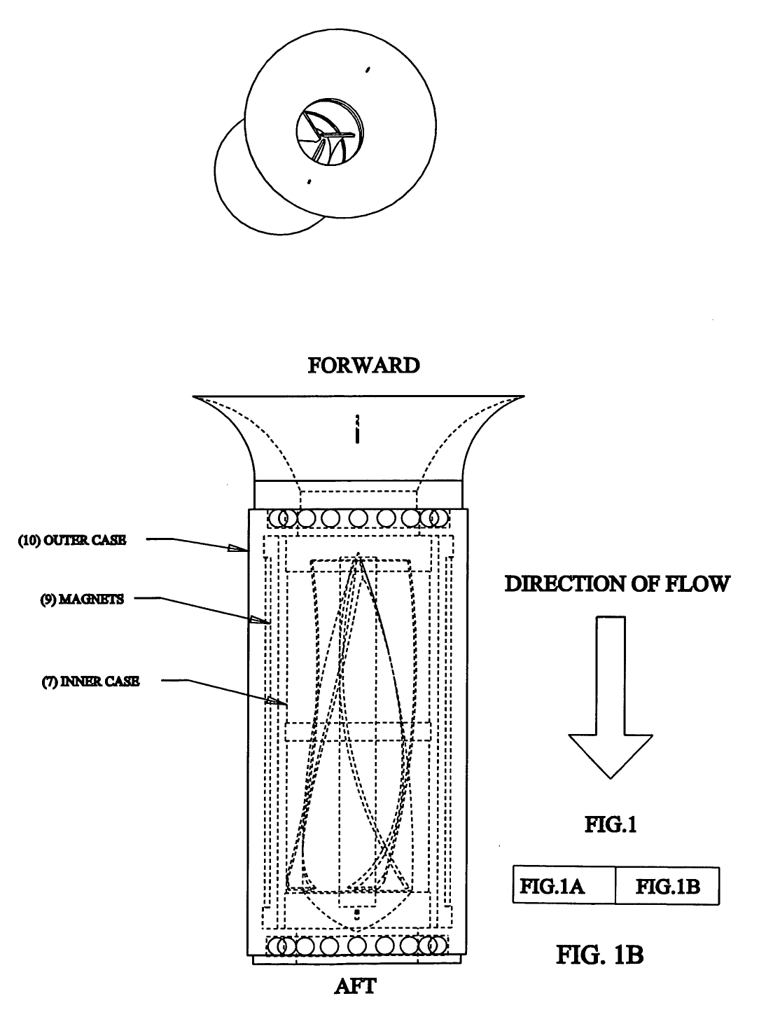

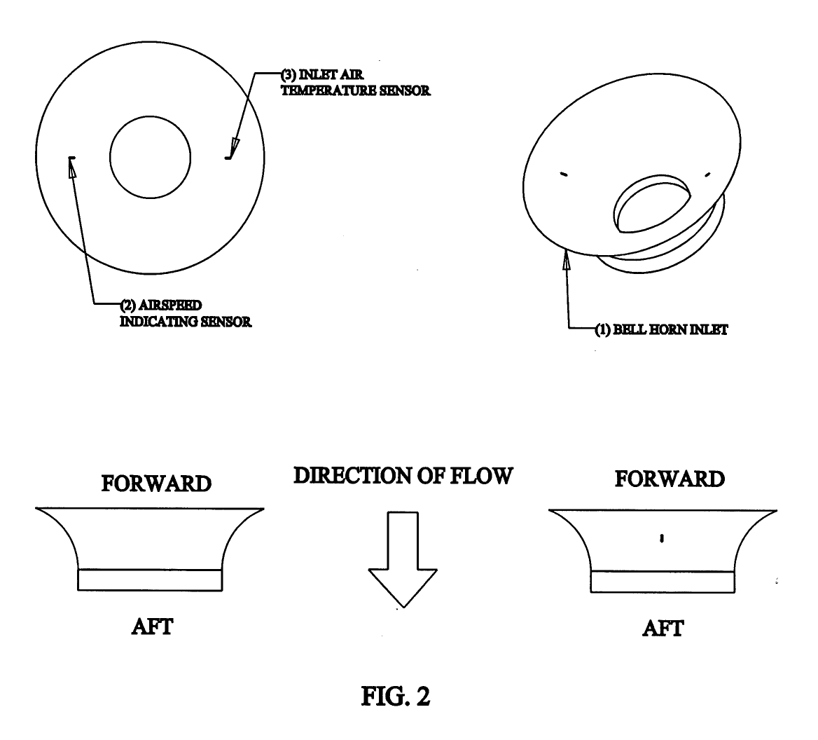

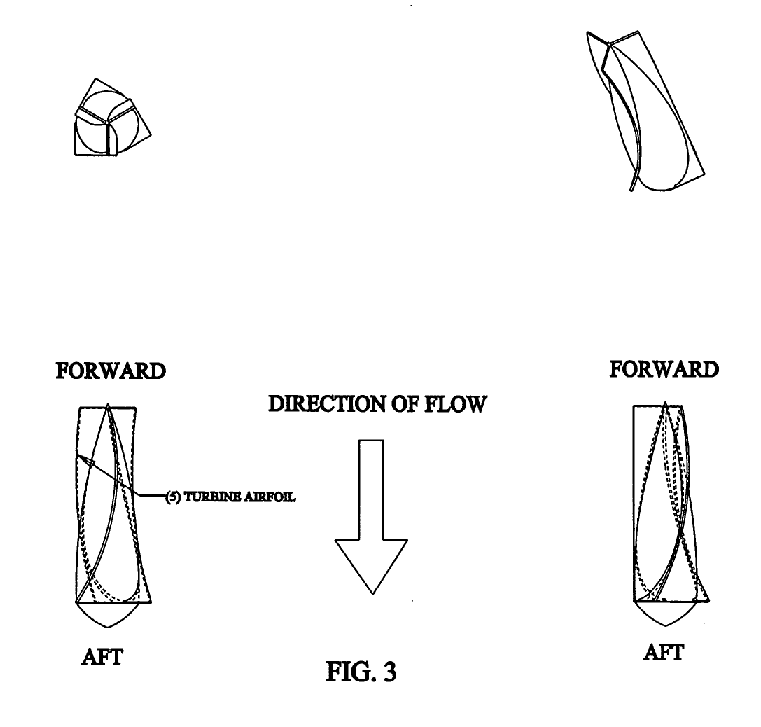

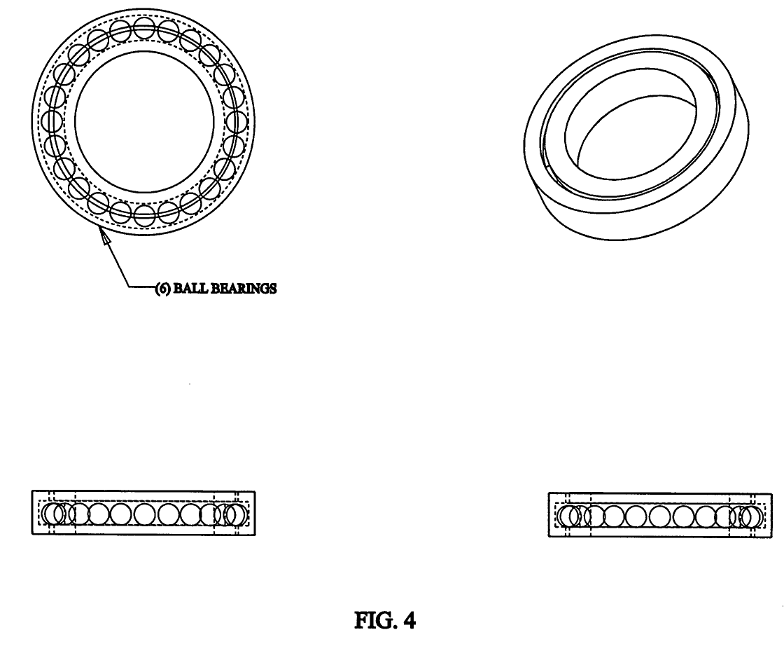

This relative wind vortex rotary turbine alternating current device consists of seventeen individual parts. (1: FIG. 2) The bell-horn inlet is specifically designed to create efficient aerodynamic flow. (2: FIG. 2) The airspeed indicating sensor for the purpose of controlling energy surges. (3: FIG. 2) An inlet air temperature sensor operates as an anti-icing system. (4) Heated elements are positioned strategically on the device for anti-icing purposes. (5: FIG. 3) Minimum of one turbine airfoil (three turbine airfoils shown in FIG. 3), built from the advanced material Karvlar™, which captures the relative wind energy and converts it to mechanical energy through this converging, parabolic rotary turbine airfoil. The turbine airfoil is specifically designed for maximum efficiency by collecting the relative wind through the bell-horn thus maximizing the wind's velocity. (6: FIG. 4) Forward and aft sealed ceramic or stainless steel ball bearings. (7: FIG. 1) The inner tubular case is made from the advanced material, Karvlar™. (8) The exterior of the inner tubular case of the rotary turbine is serpentine wrapped with copper windings thus creating the magnetic energy field. (9: FIG. 1) A minimum of three magnets are positioned on the inner surface of the outer case to create the magnetic energy field for the serpentine copper winding to pass through thus creating the electrical energy. (10: FIG. 1) The outer case of the rotary turbine is also composed of the advanced material, Karvlar™. (11) The RWVT has universal mounts to provide adaptability for any application that requires energy. (12) An armature is positioned forward or aft of the serpentine copper windings on the inner tubular case. (13) A minimum of two brushes for friction contact are included with said armature. (14) A series of springs maintain the required constant pressure on said brushes. (15) Further, the brush and spring components are placed in a housing to allow for linear movement due to wear during the life of the brush. (16) The housing for the brushes and springs has a soldered copper wire conductor. (17) The vortex generators are strategically placed for optimum performance.

### DETAILED DESCRIPTION OF THE INVENTION

The present invention considers a power plant system driven by relative wind. Relative wind is the driving force for an axial flow rotary turbine alternating current device which provides energy for operating a generator. Said rotary turbine alternating current device in turn provides a charge for battery cells, electric devices and/or a public power grid system. The electrical energy produced can be used to provide power to move a vehicle as well as operate all of its subsystems such as heat, AC, radio, lights etc. Excess energy created is stored in batteries. The vortex generators, which control surface variations to reduce air flow turbulence, are placed strategically within the component to assure optimum performance.

This relative wind vortex rotary turbine alternating current device consists of seventeen individual parts. The converging bell-horn inlet is specifically designed to increase relative wind velocity for the purpose of rotating the turbine airfoil unit at maximum efficiency. The airspeed indicating system will control energy surges. An inlet air temperature system operates the anti-icing system. Attached heated elements are positioned strategically on the device for anti-icing purposes. The turbine airfoil, made from the advanced material, Karvlar™ provides unparalleled weight savings and minimal maintenance while capturing the relative wind energy that is converted to mechanical energy through this converging, parabolic rotary turbine airfoil. The turbine airfoil is specifically designed for maximum efficiency by converging relative wind for maximum velocity. The forward and aft sealed ceramic assemblies hold the stainless steel ball bearings. The inner tubular case is also made from the advanced material, Karvlar™. The exterior of the inner tubular case of the rotary turbine is serpentine wrapped with copper windings for the purpose of generating the magnetic energy field. A minimum of three magnets are positioned on the inner surface of the outer case to create the magnetic energy field for the serpentine copper winding to pass through to create the electrical energy. The outer case is also made from the advanced material, Karvlar™. The RWVT has universal mounts allowing adaptability for all applications that require energy. The armature is positioned forward or aft of the serpentine copper windings on the inner tubular case. A minimum of two brushes are included to create the friction contact with said armature. Springs provide the required constant pressure on said brushes to assure efficiency. Further, the brush and spring components are placed in a housing to allow for linear movement due to wear during the life of the brush. The housing for the brushes and springs has a soldered copper wire conductor. Finally, the vortex generators are strategically located for optimum performance.

The rotary turbine airfoil rotates within a forward and aft sealed, circular ball bearing assembly. The ball bearings ride between an inner and an outer casing to assure a minimal friction coefficient. The RWVT will use biodegradable, plant based lubricants as well as petroleum based lubricants. The said turbine airfoil unit is designed as a converging center cone structure. The airfoils provide connectivity between the inner cone and the inner case.

1. A relative wind vortex rotary turbine alternating current device which provides energy to operate a generator for the purpose of converting relative wind energy to electrical energy.

2. A device as in claim 1 wherein the device is a free wheeling axial flow rotary turbine specifically designed for relative wind operation.

3. A device as in claim 1 wherein the device has an anti-icing control system for enabling the device to be operated in below freezing weather conditions.

4. A device as in claim 1 wherein the device has an outer cylindrical case having substantially no protrusions so that the outer cylindrical case has a smooth outer finish.

5. A device as in claim 1 wherein, in addition to vehicles and buildings, the device can be mounted anywhere relative wind is created due to changes in temperature or air pressure.

6. A device as in claim 1 wherein the device integrates into automotive or structural design with minimal impact.

7. A device as in claim 1 wherein the device is adaptable to all electrical systems.

8. A device as in claim 1 wherein the device uses a vortex generator for optimum aerodynamics.

9. A device as in claim 1 wherein the device can be used to produce energy on any moving vehicle with two or more wheels, as well as, small airplanes with naturally aspirated engines referred to as “general aviation” aircraft.

10. A device as in claim 1 wherein the device has windings as an external part of the internal rotary turbine.

11. A device as in claim 1 wherein the device is set in a forward to aft position for maximum efficiency.

12. A device as in claim 1 wherein the device uses the advanced material, Karvlar™, a composite material consisting of carbon fiber, Kevlar™, and epoxy.
